(19) United States
(12) Patent Application Publication
(10) Pub. No.: US 2025/0376577 A1
(43) Pub. Date: Dec. 11, 2025

(54) PROCESSING AID, FORMULATIONS FOR PRODUCING SAME, AND USE THEREOF

(71) Applicant: DEVINOCHEM GmbH & Co. KG, Wiesbaden (DE)

(72) Inventors: Florian ROTH, Schlangenbad (DE); Christian J. BARBE, Schlangenbad (DE); Falk GABEL, Schlangenbad (DE)

(21) Appl. No.: 18/829,510

(22) Filed: Sep. 10, 2024

(30) Foreign Application Priority Data
Jun. 7, 2024 (DE) 10 2024 115 979.0

(51) Int. Cl. C08K 13/02; C08J 3/21; C08K 3/34; C08K 5/098; C08K 5/20; C08L 53/00; C08L 71/02

(52) U.S. Cl. CPC C08K 13/02; C08J 3/212; C08L 53/00; C08L 71/02; C08J 2353/00; C08J 2371/02; C08K 2003/343; C08K 5/098; C08K 5/20

(57) ABSTRACT

The disclosure generally relates to processing aids, in particular for producing products from or comprising rubber mixtures and/or other organic polymers, for example for producing so-called elastomers. More particularly, the disclosure relates to a processing aid which provides for a good demolding or separation effect of products produced from or comprising rubber mixtures and/or other polymers, while also enabling improved application, in particular with regard to safety aspects. The disclosure relates generally to a formulation from which a processing aid can be produced and which in particular facilitates largely dust-free or at least low-dust handling of the processing aid for the end user, and also relates to a method for producing the formulation as well as to a method for producing the processing aid, and to a processing aid produced or at least producible in this way.

### TECHNICAL FIELD

The present disclosure generally relates to processing aids, in particular for producing products from or comprising rubber mixtures and/or other organic polymers, for example for producing so-called elastomers. More particularly, the present disclosure relates to a processing aid which provides for a good demolding or separation effect of products produced from or comprising rubber mixtures and/or other polymers, while also enabling improved application, in particular with regard to safety aspects. The disclosure relates generally to a formulation from which a processing aid can be produced, and which in particular facilitates largely dust-free or at least low-dust handling of the processing aid for the end user, to a method for producing the formulation as well as a method for producing the processing aid, and to a processing aid produced or at least producible in this way.

In the context of the present disclosure, formulation refers to the precursor of a processing aid, which is converted into an application-compliant delivery form and hence the processing aid by adding water, for example. This means that the formulation may come in the form of a powder, granules, or with a gel-like or paste-like consistency, which, however, is preferably still flowable and/or pumpable. Processing aids with a specific functional character may also be referred to as release agents, lubricants, anti-friction agents, anti-stick agents, demolding agents, product separation agents, or the like, depending on their function. These terms describe processing aids which are provided in a ready-to-use delivery form.

In the context of the present disclosure, powder is understood to mean a delivery form which substantially consists of particles, while particles also encompass aggregates and agglomerates. The term powder component refers to inorganic phases as well as to organic phases or mixtures of organic and inorganic phases, which are preferably provided in particulate form.

### BACKGROUND

As stated, the present disclosure generally relates to a formulation for producing a processing aid which can be used, for example, as a demolding agent or release agent, as well as to a processing aid produced or producible from this formulation. The processing aid according to the disclosure can be used, for example, in the form of a coating which acts like a release agent, and release agent is understood here to mean that it has the effect of keeping adjacent materials separable. In other words, the processing aid in this case can be understood as an agent with lubricant-like properties and can also generally be understood as a lubricant. Lubricants, or synonymously lubricating agents, are used for lubrication purposes and serve to reduce the sticking together or adhesion of surfaces to one another, hereinafter also referred to as adherence, but also to reduce friction and wear, and also for cooling purposes, for example by reducing frictional heat. The processing aid may also be implemented as a mold release agent or demolding agent, i.e. as a processing aid that prevents or at least reduces or minimizes the adhesion of cast and/or molded parts to the mold or, more generally, to a material that is used in the molding process. Furthermore, the processing aid according to the present disclosure can also act or be used as a lubricant, which is understood to mean in particular that it has a separating effect between hot surfaces or materials, for example so as to prevent a polymer melt from adhering to a hot metal surface such as the surface of a mold or of a tool. However, more generally, the processing aid can also be effective as a product release agent, for example as a product release agent that prevents the sticking of bulk material, granules and/or other preforms of a final product, in particular a polymeric final product. Generally, these aforementioned and non-exhaustive specific embodiments are subsumed under the term “processing aid” in the context of the present disclosure, which can in particular be a processing aid that has a separating effect, which generally also refers to a product separating agent here under the general generic term of a processing aid, in particular a processing aid having a separating effect.

A specific embodiment of a processing aid within the meaning of the present disclosure can be understood as a demolding agent (synonym: release agent). The processing aid of the disclosure can be used, for example, as a processing aid in the manufacture of products from or comprising rubber mixtures and/or from or comprising other organic polymers. Processing aids in the form of demolding agents include, for example, agents which are applied to the surface of the product produced from or comprising a rubber mixture and/or produced from or comprising a polymer, or onto a mold that is used to produce the product. The film of processing aid applied is usually referred to as a release agent film. In the context of the present disclosure, this applied film can also be referred to and/or understood as a coating or layer. The purpose of the processing aid, for example of the demolding agent or release agent, is to prevent the produced product from adhering to the mold and/or to another similar product. It is also possible for the product to be in the form of a long strip which is stacked or rolled for storage, and in this case the different layers of the material should also not adhere to each other. This particular embodiment is mentioned here by way of example and represents a common embodiment or application of the processing aid according to the disclosure, so that many properties of the processing aid will be described further below with reference to this particular embodiment of the demolding or release agent. However, the application of the processing aid is by no means limited to this application, rather it can also be used in other areas, as explained in detail above.

Known processing aids, in particular prior art processing aids that have a release effect, expediently comprise an agent which can be applied to the surface of either the mold or the product itself, or optionally to both, and can act there as a separating body or spacer, thus preventing direct contact of the product with another product, with itself, and/or with the mold when the processing aid is used as a demolding or release agent. In the context of the present disclosure, “direct contact” is understood to mean physical contact between the surface of the product and another surface, for example that of a mold or of another portion of the product (for example another portion of a polymer sheet), i.e. in simple terms the contact of different surfaces.

This can be the case, for example, by applying a film made of or comprising the processing aid according to the disclosure to at least one of the surfaces in question. However, it is not absolutely necessary for the processing aid to be applied to at least one surface in the form of a coating and/or a film, rather it can also be applied to the surface in the form of a powder, for example. It is also possible that the processing aid is incorporated into the material of one of the surfaces, for example into the polymeric material. The effect of the processing aid, in whatever form it is applied, is intended to prevent the surfaces from sticking together. As a mechanism, it is generally assumed that at least one component of the processing aid acts as a spacer or separating body, which prevents or at least impedes physical and/or chemical bonding between the surface of the produced product and other surfaces that come into contact with the product.

The products made from or comprising rubber mixtures and/or other polymers, such as elastomers, are produced in known production processes, for example by vulcanization. Usually, long strips of such polymers, for example elastomers, are first produced as semi-finished products, which are then formed into the actual products, for example tires, in subsequent processes. In the scope of the disclosure, a strip of a polymer, for example an elastomer, may also be denoted a sheet or belt or ribbon and refers to the shape of the polymer body, that is, a long, thin body with a thickness at least one order of magnitude smaller than its width and length. Also, the strip's length may be larger than its width. The long strips are deposited as a stack, with the surfaces touching each other. Furthermore, the surfaces of the produced polymer product come into contact with molds during the molding processes. In order to prevent the polymer surfaces from sticking to each other or to a mold, or to allow for the product made from or comprising a polymer and/or a rubber mixture to be completely released from the mold, processing aids may be used, for example a demolding or release agent as described above. For example, it may be intended to apply processing aids in liquid form to the mold or to the surface of the product produced from or comprising a rubber mixture and/or a polymer, so that a film, which can be also described as a coating or a layer of a “film coating” in the scope of the disclosure, of processing aid (generally also referred to as a “film with a release effect” or “release film” for short) will form on the corresponding surface. This then prevents surfaces from sticking together.

As stated, processing aids which cause a separating effect therefore expediently comprise at least one agent which acts as a spacer or separating body on a surface. For example, it is known that certain powder components, in particular inorganic powder components, which may be a carbonate such as CaCO₃ (“chalk”), or a layered silicate such as talc, or a clay mineral, or similar layered silicates known to a person skilled in the art, have a “releasing” effect. Other agents, in particular organic agents such as soaps, for example metal soaps, can also assume the function of a “separating body” or spacer, alternatively or additionally. In this way, the formation of a chemical and/or physical bond between the surfaces to be separated is prevented or at least is suppressed or made more difficult, so that they can be easily separated from one another. It is generally desirable with these agents which have a release effect, that they or the components of the corresponding agents exhibit a high level of adhesion or affinity to the surface of the substrate, also through interaction with the other components of the processing aid. As a result, the release film itself will exhibit strong adhesion to the surface made of or comprising the organic polymer, while it exhibits very low cohesion in the case of release film-to-release film contact.

It is desirable for such processing aids that they are provided as an inert material. In the context of the present application, this means that these processing aids, in case they react with the surface and/or the material in question, in particular a polymer, preferably do so only in such a way that the physical properties of the material, in particular of the polymer, are not altered. If these physical properties are nevertheless influenced, this will only occur in such a way that easy separation of a product, for example from a mold, is ensured, and/or that the adhesion of surfaces to each other, for example polymer surfaces such as rubber surfaces, can be prevented. In other words, the processing aid will preferably influence the physical properties of the material, preferably the polymer, in particular of a so-called “rubber”, with which it comes into contact and/or to which it is applied and/or into which it is incorporated, preferably only in such a way that the surface properties, in particular the surface energy and/or the coefficient of friction, are changed, while other properties remain unchanged.

The processing aids having a release effect are usually provided in the form of an aqueous dispersion or aqueous suspension, for example a coarsely dispersed dispersion or a fine suspension, or are used as such, for example in order to be able to apply a corresponding release agent film. For transportation purposes, the question arises as to how the processing aid should be transported appropriately. This applies in particular, but not only, to formulations as well as to processing aids made from or comprising powder components, in particular inorganic powder components. In general, it makes sense if the proportion of active substance, i.e. the substance forming the release film, is as high as possible for shipping, in order to save CO₂ for the transportation of non-active substance, for example. Therefore, it is possible, for example, to consider shipping powder components as such. Inorganic powder components in particular are very stable against decomposition processes. In this way, a transportation of 100% of active substance can therefore be assured in principle, which, as exemplified above, also makes sense from an environmental point of view.

However, a drawback thereof is that the user of the processing aid will be forced to process the powder himself or herself, which can lead to dust exposure for employees entrusted with the task. This can be desirable in the case of silicate powders, as they can contain phases that are respirable and therefore harmful from a health perspective. Also, this might contribute to the formation of explosive mixtures characterized by a specific Minimum Ignition Energy (MIE).

One way of preventing such dust exposure, in particular during the processing of the formulation into a processing aid, is to provide liquid or liquid-bound mixtures, for example the already finished processing aid itself. The difficulty here is not only that providing such a mixture, usually in the form of a dispersion or suspension, can be difficult because such a dispersion or suspension tends to be prone to demixing phenomena, such as segregation or settling of the powder component and thus separation of at least some of the liquid and solid components (in the worst case even to the formation of a solid sediment, for example), for example the settling of solid components. Even if such demixing can be prevented under shipping conditions, for example by using suitable additives, the shipping of such a mixture means that a large amount of substance not actively required to separate the surfaces must also be shipped. Overall, this is to be regarded as very unfavorable. In addition, dust may form after the processing aid has dried, for example if parts of the processing aid become detached from the surface.

For example, US patent application US 2019/0161624 A1 discloses a composition of a demolding agent or release agent which includes up to 86.5 wt % of water. The demolding or release agent according to US 2019/0161624 A1 reduces the formation of dust by the demolding agent or release agent itself.

There is therefore a need for a formulation and/or at least a processing aid that can be shipped, offered and/or delivered with a high content of active substance and which still enables excellent surface separation. At the same time, there is a need to increase user safety and application safety.

### OBJECT

The object of the present disclosure is to provide a processing aid and a formulation which overcome or at least partially mitigate the aforementioned limitations and/or deficiencies of the prior art, as well as a method for producing same.

### SUMMARY

The object of the present disclosure is achieved by the subject-matter of the independent claims. Preferred and specific embodiments will be apparent from the dependent claims and the description of the present disclosure.

According to a first aspect, the present disclosure therefore relates to a formulation, in particular a formulation for a processing aid or for producing a processing aid, which formulation comprises a non-ionic surfactant, preferably an alkoxylate, particularly preferably an ethylene-propylene block polymer, in particular preferably with a molecular mass of less than 100,000 g/mol, preferably less than 75,000 g/mol, with a preferred lower limit of the molecular mass being 200 g/mol, an anionic surfactant, and a metal soap, and which comprises not more than 10 wt % of water, preferably at most 5 wt % of water, more preferably at most 3 wt % of water, based on the total weight of the formulation. Furthermore, it has been found that (residual) water contents or additions of water as a component of a formulation in the range of more than 10 wt % to 40 wt % have an adverse effect on both flowability and pumpability. In the context of the disclosure, the formulation according to the disclosure as described above can, in simplified form, also be referred to as a “water-free”, i.e. anhydrous, formulation, while it will be appreciated that this formulation may still comprise water, but within the aforementioned narrow limits as stated, which are technically unavoidable amounts of water, i.e. an unavoidable minor constituent, which may be adsorptively bound water, for example, and or described as residual water from all or at least some of the raw materials which are comprised by the formulation.

In the context of the present disclosure, formulation is understood to mean a mixture of substances. In particular, this mixture of substances can be suitable or designed to be converted into a ready-to-use product by adding further components, for example by the end user. The formulation therefore represents a kind of chemical equivalent to a so-called “semi-finished product”.

The formulation according to the present disclosure has a number of features over the prior art. In particular, it is a formulation which can preferably be converted into a processing aid merely by adding water.

What is particularly desirable is that the formulation according to the disclosure comprises only active substance which contributes to the formation of the separating or release film on the surfaces to be separated, except for unavoidable amounts of residual water which are usually at most 10 wt %, preferably at most 5 wt %, based on the total weight of the formulation, and preferably can even be lower, for example not more than merely 3 wt %, based on the total weight of the formulation. The transportation of unnecessary components is thus avoided, which is desirable from an environmental point of view. In addition, the formulation is designed so that it can be easily converted into a processing aid by the end user, preferably by simply adding water, while the end user can adjust the active substance concentration and thus the viscosity of the processing aid to suit his or her own processes and equipment. The design of the formulation as a water-free and at the same time dust-free formulation with a very high content of active substance, which as stated is at least 90 wt % and can preferably be even higher, for example 97 wt % or even more, also takes user safety into account, since, for example, the dust exposure of employees can be kept to a minimum in this way. In the best case, dust exposure by the processing aid or the formulation itself can even be completely prevented and/or avoided.

The active substance of the formulation (and correspondingly also that of the processing aid obtained from the formulation) is generally given by the content of the formulation or of the processing aid which is not water or another solvent. The active substance of the formulation and, correspondingly, of the processing aid obtainable from the formulation generally comprises, as stated, a non-ionic surfactant, preferably an alkoxylate, in particular an ethoxylated and/or propoxylated alkoxylate, most preferably an ethylene-propylene block copolymer, in particular preferably having a molecular mass of less than 100,000 g/mol, preferably less than 75,000 g/mol, with a preferred lower limit of the molecular mass being 200 g/mol, an anionic surfactant, and a metal soap.

The non-ionic surfactant acts as a film former which during the preparation of the processing aid from the formulation together with water forms a matrix in which the separating bodies or spacers are embedded, and which therefore serves to form a release agent film. The non-ionic surfactant is preferably designed in such a way that it enables good film formation and at the same time is inert in the sense of the present disclosure vis-a-vis the polymer product, for example the rubber mixture, i.e. has no adverse impact on the application-relevant properties of the polymer, rubber mixture and/or elastomer produced.

In the context of the present disclosure, metal soap refers to salts of carboxylic acids, and therefore also to salts of fatty acids, resin acids, and naphthenic acids with metals. Metal soaps can be divided into water-soluble and water-insoluble soaps. Water-soluble metal soaps are often simply referred to as soaps. This applies in particular to the water-soluble fatty acid salts which include sodium and potassium ions, which are also referred to as soaps.

A fatty acid is generally understood to be a mostly unbranched aliphatic monocarboxylic acid. Resin acids are a heterogeneous group of organic acids which occur, for example, in natural resins. Naphthenic acids are understood here to mean carboxylic acids which comprise at least one cyclopentane and/or cyclohexane group with at least one alkyl substituent. These groups of carboxylic acids may also be generally referred to as “soap-forming carboxylic acids” in the context of the present disclosure.

In the context of the present disclosure, a water-soluble metal soap is understood to mean an alkali salt of one of the aforementioned carboxylic acids, in particular a sodium salt and/or potassium salt of one of the aforementioned carboxylic acids, for example of a fatty acid, or a mixture of these substances. The water-soluble soap can also be referred to as an alkali soap. In particular, the term “water-soluble soap” encompasses a sodium salt and/or potassium salt of a fatty acid, for example a sodium stearate and/or potassium stearate, and/or a sodium oleate and/or potassium oleate, or mixtures thereof.

Stearates belong to the group of metal soaps and, in the context of the present disclosure, comprise the salts of selected fatty acids. In the context of the present disclosure, a stearate is in particular generally understood to mean salts of the alkanoic acids margaric acid, palmitic acid, and/or stearic acid. A stearate thus comprises a salt of hexadecanoic acid (n-hexadecanoic acid), heptadecanoic acid (n-heptadecanoic acid), octadecanoic acid (n-octadecanoic acid), and/or mixtures thereof. A stearate preferably contains a salt of octadecanoic acid as a main constituent, meaning that at least 10 wt %, preferably at least 20 wt %, and preferably more than 50 wt % of the stearate comes in the form of a salt of octadecanoic acid. The alkanoic acids contained in the stearate are usually used in combination with different metals, such as calcium, zinc, magnesium, sodium, aluminum, and lithium. In this case one speaks of calcium stearate, zinc stearate, magnesium stearate, sodium stearate, aluminum stearate, and lithium stearate, among others. Technical grade calcium stearate can often contain not only calcium stearate but also other calcium salts of higher fatty acids, for example calcium palmitate.

This similarly also applies to the other metal stearates. That is, the same or similar systematic can be applied to describe other metal stearates.

All powder components are characterized by grain sizes that have been specifically selected so that the final product, in which the powder components make up 40 to 70 wt %, preferably 45-65 wt %, and particularly preferably 52-60 wt %, can be dispersed in water by virtue of the specific grain size without need to increase the water temperature to above 5° C.

According to one embodiment, it can be suggested for the formulation and/or the processing aid to comprise a biocidal constituent which increases the pot life and/or the in-can preservation of the formulation and/or of the processing aid.

Within the scope of the disclosure, the formulation comes in the form of an anhydrous formulation (i.e. with at most 10 wt % of water) and at the same time as a mass which is nevertheless displaceable and preferably even flowable, which later, in particular after shipping, can be removed from a container at the end user side, for example from the delivery container using a commercially available drum emptying system, and can accordingly be converted into a processing aid without the risk of dust formation or dust generation caused by the removal and further processing in the best case scenario. In any case, such dust formation will be significantly reduced. The formulation also has the characteristic that the water content is quite low in this way and that, despite the very low water content, dust formation in the product, i.e. the formulation, is nevertheless avoided or at least reduced. This can be achieved by the non-ionic surfactant acting as a flow aid and thus itself being able to prevent or at least reduce dust formation. Thus, the reduction of dust exposure in production and thereby the reduction of health risks caused by the formulation to employees entrusted with the processing is largely achieved by proper use of the formulation according to the disclosure.

In the context of the present disclosure, flow aid or flow agent is understood to mean a component which improves the flowability of a mixture of substances, such as a formulation according to the disclosure, for example which reduces the viscosity of such a formulation. In the context of the present disclosure, in particular non-ionic surfactants can fulfill this function, for example an alkoxylate, in particular an ethoxylated and/or propoxylated alkoxylate, most preferably an ethylene-propylene block copolymer, in particular preferably with a molecular mass of less than 100,000 g/mol, preferably less than 75,000 g/mol, with a preferred lower limit of the molecular mass being 200 g/mol.

At the same time, the composition of the formulation ensures that the later usability and processability of the formulation or of the processing aid obtained from the formulation is guaranteed. For later usability and processability, the so-called “displaceability” and, if applicable, “flowability” are desirable for the end user. “Displaceability” is generally, in the scope of the disclosure, understood to mean that a substance can be moved, for example with a spatula, can be displaced and reshaped. However, if a substance, for example a paste, is neither displaceable nor flowable, it cannot be conveyed using conventional pumps, for example, so that a different dosage form (tablet or similar) would be necessary for selective dosing. Therefore, both displaceable and flowable products are generally preferred, with flowability, in the sense of the disclosure, being understood to mean that corresponding products will flow out of a container just when holding it at an angle, driven solely by gravity. The formulation according to the disclosure enables the preparation of such both displaceable and flowable processing aids, and the displaceability and/or flowability in combination with the absence of water ensures that a high content of active substance can be diluted to the application concentration in one step in a nearly dust-free manner.

Preferably, the formulation according to one embodiment has a Brookfield viscosity of at most 500 Pa·s (500,000 mPa·s), preferably of at most 300 Pa·s. Such formulations are displaceable within the meaning of the disclosure, can also be flowable within the meaning of the disclosure, and can be conveyed using commercially available pump and drum emptying systems. This has the characteristic that the formulation as such is easy to dose and can therefore be easily integrated into existing production lines.

The individual constituents of the formulation or, correspondingly, the constituents of the active substance of the processing aid ensure that a good release effect can be achieved in a simple manner.

Here, in particular the non-ionic surfactant acts as a constituent which, especially when present in the form of an alkoxylate, most preferably as an ethylene-propylene block copolymer, preferably with a molecular mass of less than 100,000 g/mol, more preferably less than 75,000 g/mol, both ensures flowability of the formulation and can preferably contribute to achieving a sufficient release effect, in particular by supporting the formation of a film of the release agent.

The anionic surfactant also contributes to film formation, although it is preferably added in a smaller amount, since such anionic surfactants might form insoluble precipitates in the presence of cations of alkaline earth metals, for example as cations of the metal soap. Preferably, the content of an anionic surfactant in the formulation is between about 0.5 wt % and 10 wt %.

Generally, the surfactants may also be provided in the form of a mixture, i.e. the formulation and, accordingly, the processing aid produced or producible from the formulation may generally comprise more than one non-ionic surfactant and/or more than one anionic surfactant. Insofar as the disclosure refers to the content of a surfactant, regardless of whether it is a non-ionic or anionic surfactant, it is understood that these quantities refer to the total content of non-ionic or anionic surfactants in each case.

Finally, the metal soap of the formulation acts as a release agent component in the processing aid. It has been found that with the formulation according to embodiments, a processing aid can be obtained or is obtained in which the metal soap as mentioned is embedded in the release agent film that is obtained by mixing surfactants as explained above. Preferably, it may be intended for the metal soap to come in the form of a stearate or at least comprise one.

The anionic surfactant or the surfactant mixture (or mixture of surfactants) comprising anionic surfactants or consisting of anionic surfactants can cooperate with the metal soap, in particular with a stearate, preferably a magnesium stearate, in such a way that, for example, that no subsequent dusting effect of the processing aid occurs, for example after the film of the processing aid has been applied to a polymer surface, even though magnesium stearates are characterized by a high tendency to form dust due to their fine grain size (powder with a small average particle size) and their low bulk density, which is also reflected in a very low Minimum Ignition Energy (MIE): Minimum Ignition Energy (MIE): <10<100<1000 mJ.

It has been found that a metal soap such as magnesium stearate is desirable because in this way the affinity of the film of the processing aid to the polymer surface can be improved, i.e. a particularly uniform film will be formed. The use of a water-insoluble metal soap such as magnesium stearate in the formulation and/or the processing aid according to the disclosure is therefore preferred. At the same time, the water-insoluble metal soap, for example magnesium stearate, can also act as a defoamer, i.e. at least somewhat reduce the foaming of the processing aid. However, it has also been found that a water-insoluble metal soap, in particular magnesium stearate, can have a negative impact on the flowability of the formulation, in particular by increasing the viscosity.

Although the water-insoluble metal soap preferably comes in the form of a stearate, the disclosure is not limited to such embodiments. Rather, it is also possible and may even be preferred, depending on the specific embodiment, that, alternatively or additionally, the water-insoluble metal soap comes in the form of another salt of a carboxylic acid, for example a salt of oleic acid (oleate). Where reference is made in the context of the disclosure to the content of water-insoluble metal soap, this is understood to mean the total content of the water-insoluble metal soaps included in the formulation and/or the processing aid or the active substance of the processing aid. This similarly also applies if the formulation or the processing aid comprises a water-soluble soap.

According to one embodiment, the formulation furthermore comprises at least one water-soluble soap, preferably a sodium stearate. Sodium stearate is a particularly preferred constituent of the processing aid or of the underlying formulation (that is, the formulation obtained from the respective processing aid) according to the present disclosure, in particular in combination with the water-insoluble metal soap. It also improves the resulting release effect of the film of the processing aid (that is, the film and/or coating that results from application of the processing aid). Unlike the water-insoluble metal soap, however, a water-soluble soap usually leads to an increase in foam formation, so that it can be helpful to match the water-insoluble metal soap and the water-soluble soap in terms of their respective contents.

Preferred embodiments are those in which the water-insoluble metal soap is made of magnesium stearate or comprises magnesium stearate, and the water-soluble soap is made of sodium stearate or comprises sodium stearate.

In fact, tests have shown that magnesium stearate is an agent which, as explained above, can lead to a well-adhering uniform release film, for example on a polymer surface, and is therefore generally suitable for imparting a good release effect to a processing aid which is or can be produced from the formulation. This is also attributed to the fact that magnesium stearate does not soften abruptly, due to its melting point of 140° C., but rather very continuously and therefore very evenly, which is beneficial for the formation of a release film that is homogeneous in terms of its thickness. Magnesium stearate as a constituent of the formulation or processing aid also reduces the foaming tendency thereof. At the same time, however, it has a negative effect on the flowability of the formulation. However, by adding a water-soluble soap such as sodium stearate it is possible to adjust the flowability of the processing aid. Although the addition of the water-soluble soap in turn has a negative effect on foam formation, as it generally leads to an increase in the tendency to foam, the interaction of the water-soluble soap and the water-insoluble metal soap results in a good tradeoff between the tendency to foam, the formation of a release film with a good release effect, and flowability. This can be seen in particular in the combination of magnesium stearate and sodium stearate as constituents of the formulation or of the processing aid produced or producible from the formulation.

In general, however, it is also possible for the water-soluble soap to comprise an oleate or to come in the form of an oleate, for example, as an alternative or in addition to a stearate. However, stearates may be preferred in this case, because they exhibit the smallest (or narrowest) possible melting range (“melting range” because the commercially available salts of carboxylic acid such as stearates are generally rarely pure, as already mentioned above, but often come as mixtures of different salts, for example comprising palmitates or the like in addition to stearates, and therefore do not melt at exactly one point, but over a range). Stearates, which usually melt at temperatures between 110-250° C., are therefore particularly preferred for this component.

In particular, it is preferred within the scope of the present disclosure if the water-soluble soap comprises sodium ions as cations or, in the case of a mixture of water-soluble soaps, these come in the form of sodium salts. In the context of the present disclosure, this is generally understood to mean that in these embodiments potassium is only present as an unavoidable impurity, usually in a concentration of not more than 500 ppm by weight. In the context of the present disclosure, this is also referred to as “technical purity”, based on the metal content.

Sodium is helpful because in the form of an ion (Na⁺), its ionic radius of about 1 Å is significantly smaller than the ionic radius of potassium (K⁺) of about 1.38 Å, and is therefore significantly more mobile and can diffuse more easily, for example. The described positive effect of improving the flowability of the formulation will therefore be more pronounced for the sodium salts of the soap-forming carboxylic acids, which can also be referred to as “sodium soaps” in the context of the disclosure, as already mentioned above, than for the potassium soaps.

The adding of at least one water-soluble soap moreover has the general effect, without being limited to a specific embodiment of the water-soluble soap as containing a stearate and/or containing sodium, that such a soap has a wetting effect and in particular exhibits good affinity for rubber mixtures and/or other organic polymers, in particular elastomers, i.e. it ensures good wetting of the surface, for example of an elastomer, by the release film. At the same time, these soaps do not interfere with the cross-linking reactions of materials like rubber mixtures (vulcanization), for example.

According to one embodiment, the formulation comprises a water-insoluble carboxylic acid amide, and preferably the water-insoluble carboxylic acid amide is or comprises ethylene distearylamide.

The water-insoluble carboxylic acid amide, for example a diamide, preferably a diamide of one or more long-chain carboxylic acids, preferably a diamide of a long-chain alkanoic acid, in particular a long-chain unbranched, more particularly a long-chain unbranched and saturated alkanoic acid, most preferably ethylene distearylamide (also abbreviated as EBS), preferably comes in the form of a waxy, per se also meltable component, and is also able to act as a release agent component, in particular together with the metal soap and/or the water-soluble soap, if present. The water-insoluble carboxylic acid amide preferably has 35 to 40 carbon atoms and/or a molar mass of less than 1000 g/mol. The water-insoluble carboxylic acid amide can also have a helpful effect on foam formation, i.e. contribute to a reduction in foaming in the processing aid resulting from the formulation. As already mentioned above, the water-insoluble carboxylic acid amide may be a diamide, preferably a diamide of a long-chain carboxylic acid, preferably a diamide of a long-chain alkanoic acid, in particular of a long-chain unbranched alkanoic acid. A preferred embodiment of the carboxylic acid amide is ethylene distearylamide, which is often also referred to as ethylene bis(steramide) and abbreviated “EBS”. Ethylene distearylamide is a preferred embodiment of a waxy meltable component and cooperates particularly well with stearates, for example.

The combination of mechanical spacers, which are formed in particular from the water-insoluble carboxylic acid amide, and the metal soap(s), which can be water-soluble soaps or alternatively or additionally water-insoluble metal soaps, therefore provides for a particularly good release effect for the processing aid and/or the film obtained therewith resulting from the formulation and also improves its processability.

Preference is given to those formulations (or processing aids produced or producible therefrom in a corresponding manner) which exhibit at least one of the following features:
The ratio between the total content of surfactants and the total content of metal soaps (i.e. the sum of the contents of water-soluble soap and water-insoluble metal soap) is between 1:0.5 and 1:2.0. This provides for a good release effect and at the same time good wetting of the polymer surface by the processing aid resulting from the formulation.
The formulation comprises a water-insoluble carboxylic acid amide which, as explained above, supports the release effect and can functionally be described as a “spacer”. In other words, the water-insoluble carboxylic acid amide acts as a spacer. The ratio between the total content of surfactants and the total content of carboxylic acid amide is between 1:0.1 and 1:0.6, preferably between 1:0.155 and 1:0.4. This reduces foam formation in the processing aid resulting from the formulation in a desirable manner, while at the same time ensuring good wetting and/or adherence of the film of the processing aid on a polymer surface.
The formulation comprises a water-insoluble carboxylic acid amide and metal soaps. In the release film applied from the formulation and then from the processing aid, these components act primarily as separators or spacers that prevent the direct contact between different surfaces as described above. The ratio between the components acting as flow agents, in particular the non-ionic surfactants, and the total content of spacing agents is between 1:1 and 1:5, preferably between 1:1.5 and 1:3. In this way, a good tradeoff is achieved between the resulting flowability of the formulation and the resulting release effect of the film made by the processing aid.

According to one embodiment, the formulation or, correspondingly, the processing aid resulting therefrom comprises a water-soluble polymer, and the water-soluble polymer is or comprises a cellulose, a polyacrylic, polyvinyl alcohol, a polyethylene, a polyurethane, a polysaccharide, for example xanthan, and/or a melamine resin, and preferably is or comprises a polyvinyl alcohol.

An embodiment that includes a water-soluble polymer can be helpful for film formation in the application of the processing aid. It is helpful if the water-soluble polymer is or comprises a polyvinyl alcohol. It has been found that polyvinyl alcohol (PVA) is inert in the sense of the disclosure, i.e. it does not affect the properties of the products of a polymer and/or a rubber mixture produced or to be produced, or at least does not interfere with them, but merely results in a separating effect and/or contributes to a separating effect. In addition, this component can also be added to the formulation in such a way that a formulation which is free of PVA per se is filled into so-called water-soluble envelopes (which may also be denoted bags or wrappers in the scope of the disclosure) which are used, for example, for transportation, positioning and/or protection against exposure to chemicals, and so that PVA passes into the processing aid as a functional component as a result of the dissolution of these packages during the preparation of the dispersion or suspension. In other words, the formulation in this case also encompasses embodiments in which, for example, the formulation comes in the form of a portioned tab in an envelope (or a bag or wrapper) made of PVA-comprising water-soluble polymer. The envelope, bag and/or wrapper may form a packaging, such that the tab may be described as packaged within said water-soluble polymer. Such an embodiment can be particularly preferred in terms of handling, because in this way the contact of a user with other substances, in particular powdery substances, in non-water-bound form or, more generally, liquid-bound form can be kept to a minimum. In this embodiment, the formulation has only a very low water content within the general limits mentioned above, since otherwise appropriate and/or controlled portioning is not possible.

According to one embodiment, the formulation comprises at least one inorganic powder component, and the inorganic powder component or the total of inorganic powder components preferably makes up no more than 10 wt %, based on the total weight of the formulation. In other words, the amount of the inorganic powder component or, in the case of the presence of a plurality of inorganic powder components the total amount, is preferably at most 10 wt %, based on the total weight of the formulation. The inorganic powder component is preferably selected from the group consisting of a layered silicate or an organically modified layered silicate, such as bentonite, montmorillonite, smectite, stevensite, hectorite, sepiolite, talc, a carbonate, for example CaCO₃, a zeolite, a kaolin and/or a silicic acid also known as silica. A powder component comprising inorganic phases or one inorganic phase or a plurality of inorganic phases, in particular inorganic, in particular preferably inorganic non-metallic phases, is also referred to as a separator component which is based on an inorganic phase and can be added as a powder component in the context of the disclosure. More particularly, these can be layered silicates, as mentioned above. Insofar as reference is made to the content of the separator component, the total content is taken as the basis if a plurality of separator components based on an inorganic phase are present, as is also the case for the other components.

Such inorganic powder components as described above are known and frequently used components of processing aids which have a separating effect. It can therefore be possible to add these inorganic powder components or at least one inorganic powder component to the formulation and/or the processing aid. The inorganic powder components mentioned above as examples are in part at least partially crystalline, but amorphous powder components (such as silicic acid) can also be used in addition to crystalline or at least partially crystalline powder components. Although these powder components are effective in terms of their separating effect, as powders they are also a cause of possible dust formation. Therefore, their use in a formulation according to embodiments is possible in principle, but generally not preferred. However, the absence of water in the processing aid or the formulation, apart from unavoidable amounts, and the choice of the non-ionic surfactant (e.g. a block polymer) are considerations for ensuring that inorganic powder components which tend to exfoliate can be added without further consideration. Storage stability and shelf life of the processing aid is not limited or endangered thereby. However, a combination of the embodiment of the formulation in the form of a prefabricated tab with an envelope (or bag or wrapper) made of or comprising PVA and an amount of an inorganic powder component may even constitute a preferred embodiment. This is because the dusty component will be incorporated in a way that is harmless to the user in this case. However, the fillers or rheology additives can also be incorporated and fixed in the structure of the processing aid (see e.g. the role of Na oleate, the role of block polymers) in such a way that black uncolored release films are obtained, which do not show any abrasion and therefore do not form dust, even if fillers or rheology additives in the form of inorganic components are added. If the release films appear to be too transparent and therefore not visible enough and inconspicuous, they may also be dyed by adding a colorant, for example one or more pigments. This form of colorants, preferably pigments, are additives that alone produce a certain coloration through a color location shift (Delta-E>1).

In other words, the disclosure therefore also relates to a product comprising the formulation according to any embodiment and an envelope (or bag or wrapper), preferably made of or comprising PVA, which envelope particularly preferably surrounds the formulation at least partially, preferably completely.

According to one embodiment, the formulation and/or the processing aid therefore comprises a colorant, preferably a pigment.

According to a further embodiment, the formulation and/or the processing aid does not comprise any insoluble particles of a polymer.

The disclosure also relates to a method for producing a formulation, preferably a formulation according to any embodiment. This method comprises a step of mixing a non-ionic surfactant, preferably an alkoxylate, in particular an ethoxylated and/or propoxylated alkoxylate, most preferably an ethylene-propylene block copolymer, in particular preferably with a molecular mass of less than 100,000 g/mol, preferably less than 75,000 g/mol, with a preferred lower limit of the molecular mass being 200 g/mol, an anionic surfactant, and a metal soap, preferably using a process which ensures a low input of shear energy. This low input of shear energy can be adjusted and controlled by ensuring that the temperature of the mixture of the components from which the formulation and/or the processing aid is to be prepared does not rise by more than 30 K compared to the initial temperature of the mixture within a process duration of 40 minutes, i.e. until the end of the process. The process may preferably involve a kneading process, a circular dissolver with a flat unstructured or double suction disk, a powder mixer, which can be operated both continuously and discontinuously.

Furthermore, the disclosure also encompasses a method for producing a processing aid, comprising the steps of:
providing a formulation according to any embodiment of the disclosure and/or produced or producible by a method according to the disclosure;
adding a liquid, preferably an aqueous liquid;
introducing shear energy or ensuring circulation and flow profiles created by a flow of the medium against the container wall so as to obtain a suspension and/or dispersion.

The disclosure thus also generally relates to a processing aid produced or producible from a formulation according to any embodiment of the disclosure and/or produced or producible by a method according to the disclosure, wherein the processing aid is produced or producible by a method according to the disclosure.

The content of non-ionic surfactant is preferably in a range from 25 wt % to 65 wt %, based on the total weight of the formulation or on the weight of the active substance in the processing aid, respectively.

The content of water-insoluble metal soap ranges from 20 wt % to 45 wt %.

Wherever the content of a component is mentioned, this is understood to mean the total content of the component, i.e. if a plurality of non-ionic surfactants are included, the total content of non-ionic surfactants. This similarly also applies to all other components.

All information on the contents of the components here refers to the total weight of the formulation or to the content of active substance in the processing aid, respectively. The information is given in percent by weight (wt %).

The content of anionic surfactant, if present, is generally, without being limited to a particular embodiment, preferably in the range of up to 3 wt %, preferably in the range between 0.25 wt % and 3 wt % of the formulation and/or the processing aid.

If included, the content of water-soluble carboxylic acid amide in the formulation and/or in the processing aid is generally, without being limited to a particular embodiment, preferably at least 5 wt % and preferably at most 15 wt %.

If included, the content of water-soluble soap in the formulation and/or in the processing aid is generally, without being limited to a particular embodiment, preferably up to 15 wt %, for example at least 5 wt % and up to 15 wt %.

If included, the content of water-soluble polymer in the formulation and/or in the processing aid is generally, without being limited to a particular embodiment, up to and not more than 5 wt %.

If included, the pigment content of the formulation and/or the processing aid is generally, without being limited to a particular embodiment, up to and not more than 3 wt %.

### EXAMPLES

The present disclosure will now be explained in further detail by way of two compositions. The specified composition information refer to percent by weight (wt %) of active substance (based on the processing aid), or to the formulation. It should be noted that the components are summarized here and that the non-ionic surfactant, for example, may well be a mixture of a plurality of surfactants. This similarly applies to the other components.

As can also be seen from the table below, certain substances can fulfil different functions and, for example, contribute to film formation and at the same time create or support the separating effect of the release agent.

As the following tabular overview shows, formulations that guarantee the desired properties can be produced using the appropriate components. In particular the comparison of the comparative example and the illustrative embodiment illustrate the relationship of the ratio between the total of the components which also influence flowability and the total of components which act as spacers, also referred to as spacing agents. The components which are summarized to the total of spacing agents include the block polymers, the water-soluble soaps as well as the water-insoluble metal soaps and, as already mentioned above, the water-insoluble carboxylic acid amides. The ethylene-propylene block copolymer is a component which is made up of at least two chemically different homopolymer chains (or blocks) which are linked to one another and which, due to their amphiphilicity, act both hydrophilically (i.e. water-loving) and lipophilically (i.e. fat-loving). This component has a dual function here, as it acts as a “flow aid” alongside, for example, another suitable non-ionic surfactant such as propylene glycol. The ratio between the total of the components whose function can be described as a flow aid and the total of the components whose function has been described as a spacing agent should be 1:2.75 in order to ensure a flowable formulation.

| | | Comparative | Illustrative |
|---|---|---|---|
| Component | Function | example | embodiment |
| Non-ionic surfactant | film former | 18 | 42 |
| Ethylene-propylene block | film former | 0 | 31 |
| copolymer | spacer | | |
| | flow aid | | |
| Metal soap | | | |
| water-insoluble metal | release agent | 63 | 33 |
| soap | component spacer | | |
| water-soluble soap | release agent | 17 | 12 |
| | component spacer | | |
| Anionic surfactant | film former | 4 | 1 |
| Water-insoluble | spacing agent | 13 | 10 |
| carboxylic acid | release agent | | |
| amide | component spacer | | |
| Water-soluble polymer | film former | 2.5 | 2.0 |
| Inorganic powder | separator | optional | optional |
| component | component spacer | | |

Summarized by functions, the following compilation results for the two compositions:

| | Comparative | Exemplary |
|---|---|---|
| | example | embodiment |
| Total of surfactant components | 22 | 43 |
| Total of anionic surfactants | 4 | 1 |
| Total of spacing agent | 75 | 85 |
| components | | |
| Total of water-soluble | 2.5 | 1.7 |
| polymers | | |
| Total of additives | 1.5 | 1.3 |
| Total of flow aids | 5 | 31 |
| Ratio flow aids:spacing agents | 1:15 | 1:2.75 |

The two compositions listed therefore differ very significantly in the proportions of the component that determines and ensures the degree of flowability of the formulation described above. In the comparative example, this component is propylene glycol, which almost only influences the displaceability and flowability, but otherwise—according to the findings obtained by DoE-does not influence any other target properties.

In contrast, the composition of the example according to the disclosure contains a component which, while primarily ensuring the flowability of the formulation, also contributes to the release effect and film formation. It is therefore included in the composition of the present example in a significant amount, which could only be achieved at the expense of a reduction in the stearate content in particular. Surprisingly, however, this does not lead to a deterioration in the target properties, namely release effect and tendency of the substrate surface to stick together, in further processing steps or as a function of storage time.

1. A formulation for producing a processing aid, the formulation comprising
a non-ionic surfactant, having a molecular mass of less than 100,000 g/mol, and
a water-insoluble metal soap,
wherein the formulation comprises at most 10 wt % of water, based on a total weight of the formulation.

2. The formulation of claim 1, further comprising an anionic surfactant.

3. The formulation of claim 1, exhibiting a Brookfield viscosity of at most 500,000 mPa·s.

4. The formulation of claim 1, further comprising a water-insoluble carboxylic acid amide.

5. The formulation of any claim 1, further comprising a water-soluble soap.

6. The formulation of claim 1, having at least one of the following features:
a ratio between a total content of surfactants and a total content of metal soaps is between 1:0.5 and 1:2.0;
the formulation comprises a water-insoluble carboxylic acid amide which acts as a spacing agent, and the ratio between the total content of surfactants and a total content of carboxylic acid amide is between 1:0.1 and 1:0.6; or
the formulation comprises a water-insoluble carboxylic acid amide and metal soaps, and the ratio between components of the formulation acting as flow agents, and a total content of spacing agents is between 1:1 and 1:5.

7. The formulation of claim 1, comprising a water-soluble polymer.

8. The formulation of claim 1, comprising at least one separator component which is based on an inorganic phase, wherein the separator component constitutes no more than 10 wt %, based on a total weight of the formulation.

9. The formulation of claim 8, wherein the at least one separator component is selected from the group comprising a layered silicate or an organically modified layered silicate.

10. The formulation of claim 1, further comprising a colorant.

11. A product comprising the formulation of claim 1 and an envelope.

12. A method for producing a formulation, comprising the step of mixing a non-ionic surfactant with a molecular mass of less than 100,000 g/mol, an anionic surfactant, and a water-insoluble metal soap.

13. A method for producing a processing aid, comprising the steps of:
providing a formulation;
adding a liquid; and
introducing shear energy or ensuring circulation and flow profiles created by a flow of a medium against a container wall so as to obtain a suspension and/or dispersion.

14. A processing aid, producible from the formulation of claim 1.

15. The formulation of claim 1, wherein the non-ionic surfactant includes an alkoxylate having a molecular mass of less than 75,000 g/mol, and wherein the water-insoluble metal soap includes a magnesium stearate and/or a calcium stearate or mixtures thereof, wherein the formulation comprises at most 5 wt % of water.

16. The formulation of claim 15, wherein the non-ionic surfactant includes an ethoxylated and/or propoxylated alkoxylate with a lower limit of the molecular mass being 200 g/mol, and wherein the formulation comprises no more than 3 wt % of water.

17. The formulation of claim 16, wherein the non-ionic surfactant includes an ethylene-propylene block copolymer.

18. The formulation of claim 4, wherein the water-insoluble carboxylic acid amide includes a diamide.

19. The formulation of claim 18, wherein the diamide includes a diamide of one or more long-chain carboxylic acids.

20. The formulation of claim 18, wherein the diamide has 35 to 40 carbon atoms and/or a molar mass of less than 1000 g/mol.
